(19) United States
(12) Patent Application Publication
(10) Pub. No.: US 2024/0397408 A1
(43) Pub. Date: Nov. 28, 2024

(54) AI/ML MODEL MOBILITY SUPPORT METHOD, SYSTEM, AND DEVICE

(71) Applicants: RAKUTEN SYMPHONY, INC., Tokyo (JP); Rakuten Mobile, Inc., Tokyo (JP)

(72) Inventors: Subramanya CHANDRASHEKAR, Indore (IN); Koichiro KITAGAWA, Tokyo (JP)

(21) Appl. No.: 18/253,921

(22) PCT Filed: Jan. 30, 2023
(86) PCT No.: PCT/US2023/011867

§ 371 Date: May 23, 2023

(51) Int. Cl. H04W 48/12; H04W 8/26; H04W 76/27

(52) U.S. Cl. CPC H04W 48/12; H04W 8/26; H04W 76/27

(57) ABSTRACT

A user equipment (UE) includes a memory having non-transitory instructions stored therein and a processor coupled to the memory, and being configured to execute the instructions, thereby causing the UE to, while operating in a connected mode, receive each of a zone identifier and a UE identifier from a first radio access network (RAN) node of a RAN. The zone identifier corresponds to a zone of the RAN including a plurality of cells and a plurality of RAN nodes including the first RAN node. The UE stores each of the zone identifier and the UE identifier in a storage device and transmits the zone identifier and the UE identifier to a second RAN node responsive to returning to the connected mode from an inactive or idle mode, or receiving, from the first RAN node or a third RAN node, a radio resource control (RRC) handover command corresponding to a handover to the second RAN node.

### TECHNICAL FIELD

This description relates to a method, system, device, and non-transitory computer-readable medium directed to automated support of user equipment (UE) mobility in telecommunication systems including application of artificial intelligence and machine learning (AI/ML) models.

### BACKGROUND

A telecommunication, e.g., cellular, system can include a large numbers of cells having service coverage provided by multiple vendors. A user equipment (UE), e.g., a cell phone, is typically capable of operating in connected, idle, and inactive modes and is often transported among the various cells and multiple vendors. When operating in a given cell, the UE has access to and from a radio access network (RAN) through a network node and becomes actively connected to the RAN when it switches from the inactive or idle mode into the connected mode. Switching between cells operated by different vendors is generally accomplished through a handover operation.

### SUMMARY

In some embodiments, a UE includes a memory having non-transitory instructions stored therein and a processor coupled to the memory, and being configured to execute the instructions, thereby causing the UE to, while operating in a connected mode, receive each of a zone identifier and a UE identifier from a first RAN node of a RAN, wherein the zone identifier corresponds to a zone of the RAN including a plurality of cells and a plurality of RAN nodes including the first RAN node, store each of the zone identifier and the UE identifier in a storage device of the UE, and transmit the zone identifier and the UE identifier to a second RAN node responsive to returning to the connected mode from an inactive mode or an idle mode, or receiving, from the first RAN node or a third RAN node, a radio resource control (RRC) handover command corresponding to a handover to the second RAN node.

In some embodiments, a RAN node includes a memory having non-transitory instructions stored therein and a processor coupled to the memory, and being configured to execute the instructions, thereby causing the RAN node to receive a transmission from a UE as part of establishing a connected mode session including the RAN node serving the UE, in response to the transmission including a first zone identifier and a UE identifier, compare the first zone identifier to a second zone identifier of a zone of a RAN including a plurality of cells and a plurality of RAN nodes including the RAN node. In response to a match between the first and second zone identifiers, the RAN node retrieves, from a storage device, an existing AI/ML-based model associated with the UE identifier based on a previous session including one of the plurality of RAN nodes serving the UE, or in response to a mismatch between the first and second zone identifiers or the transmission lacking the first zone identifier, generates a new AI/ML-based model. The RAN node transmits the corresponding existing or new AI/ML-based model, the UE identifier, and the second zone identifier to the UE.

In some embodiments, a method of operating a RAN includes transmitting a UE identifier and a zone identifier from a first node of the RAN to a UE, wherein the zone identifier corresponds to a first zone of the RAN including a plurality of cells and a plurality of nodes including the first node, storing each of the UE identifier and the zone identifier in a storage device of the UE, transmitting the UE identifier and the zone identifier from the UE to a second node of the RAN, sending an AI/ML-based model and policy parameters from the second node to the UE, wherein the AI/ML-based model and policy parameters are based on the UE identifier and the zone identifier, and applying the AI/ML-based model and policy parameters to an operation of the UE.

### BRIEF DESCRIPTION OF DRAWINGS

Aspects of the present disclosure are best understood from the following detailed description when read with the accompanying figures. In accordance with the standard practice in the industry, various features are not drawn to scale. In fact, the dimensions of the various features are arbitrarily increased or reduced for clarity of discussion.

FIG. 1 is a diagram of a communication system, in accordance with some embodiments.

FIG. 2 is a flowchart of an AI/ML model mobility support method, in accordance with some embodiments.

FIG. 3 is a flowchart of an AI/ML model mobility support method, in accordance with some embodiments.

FIG. 4 a flowchart of an AI/ML model mobility support method, in accordance with some embodiments.

FIG. 5 is a diagram of a processor-based device, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation or position of a first feature over or on a second feature in the description that follows include embodiments in which the first and second features are formed or positioned in direct contact and include embodiments in which additional features are formed or positioned between the first and second features, such that the first and second features are in indirect contact. In addition, the present disclosure repeats reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, are used herein for ease of description to describe one element or feature's relationship to another element(s) or feature(s) as illustrated in the figures. The spatially relative terms are intended to encompass different orientations of a system or object in use or operation in addition to the orientation depicted in the figures. The system is otherwise oriented (rotated 90 degrees or at other orientations) and the spatially relative descriptors used herein likewise are interpreted accordingly.

In various embodiments, some or all of a method, system, device, and computer readable medium are directed to RAN operations including transmitting a UE identifier and a zone identifier from a first node of the RAN to a UE, wherein the zone identifier corresponds to a first zone of the RAN including a plurality of cells and a plurality of nodes including the first node, storing each of the UE and zone identifiers in a storage device of the UE, transmitting the UE and zone identifiers from the UE to a second node of the RAN, sending an AI/ML-based model and policy parameters from the second node to the UE, wherein the AI/ML-based model and policy parameters are based on the UE identifier and the zone identifier, and applying the AI/ML-based model and policy parameters to an operation of the UE.

By storing the zone and UE identifiers in the UE and transmitting the zone and UE identifiers from the UE to the second node, the second node is able to determine or retrieve whether previously generated AI/ML-based model information is available to be transmitted to the UE, e.g., from a database associated with the zone identifier. The previously generated AI/ML-based model information, e.g., an AI/ML-based model and policy parameters, is thereby available to be applied by the UE to operations in scenarios in which the previously generated AI/ML-based model information would otherwise be unavailable, e.g., while the UE transitions from inactive or idle mode to connected mode or as part of a UE handover operation. Compared to approaches in which previously generated AI/ML-based model information is unavailable in such scenarios, the system, UEs, and nodes are thereby configured such that UE operations are more efficient by being able to leverage the previously generated AI/ML-based model information.

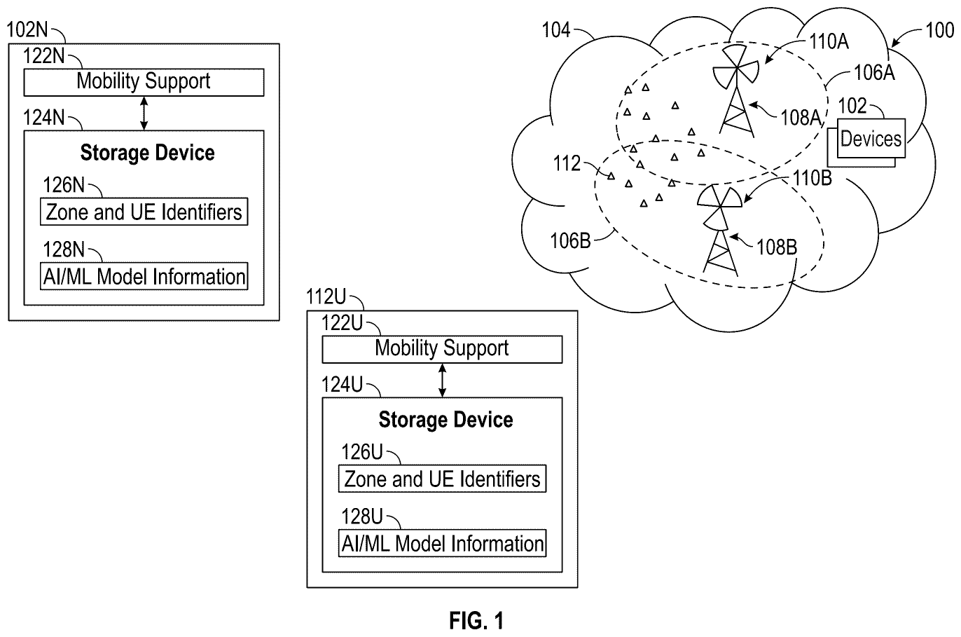

FIG. 1 is a diagram of a telecommunication system 100 (hereinafter referred to as “system 100”), in accordance with some embodiments. FIG. 1 is simplified for the purpose of illustration.

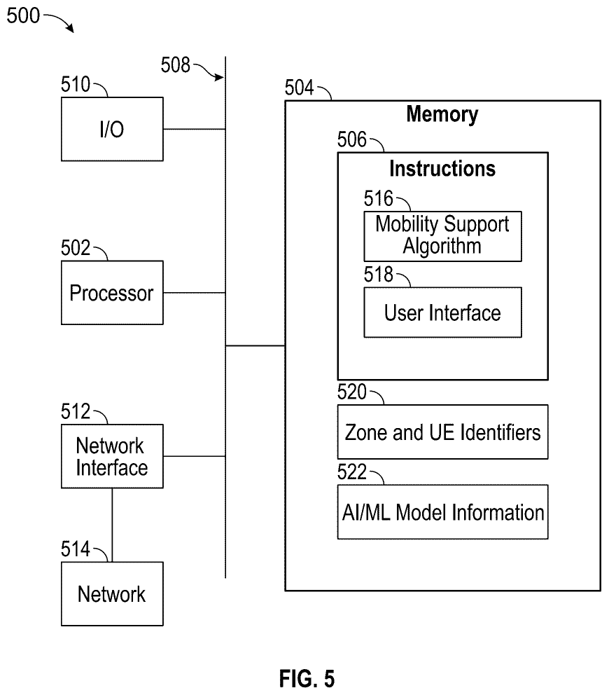

System 100 includes a plurality of interconnected devices 102 configured as some or all of a network 104. In various embodiments, devices 102 correspond to combinations of computing devices, computing systems, servers, server clusters, and/or pluralities of server clusters also referred to as server farms or data centers in some embodiments. In some embodiments, a device 500 discussed below with respect to FIG. 5 is an embodiment of a device 102.

In some embodiments, one or more of devices 102 are virtualized network components, e.g., virtualized network functions (VNFs), including software configured to implement one or more network functions by running on one or more hardware devices. In some embodiments, some or all of devices 102 are configured as some or all of a network function virtualization infrastructure (NFVI). Other configurations and/or types of devices 102 are within the scope of the present disclosure.

FIG. 1 depicts an instance of devices 102, a device 102N, that is further discussed below.

In some embodiments, network 104 includes one or more radio access networks (RANs) or a portion of a RAN, e.g., a zone as further discussed below. In some embodiments, a RAN is a mobile telecommunication system that implements a radio access technology (RAT) and resides between instances of user equipment (UE) 112, e.g., mobile phones, computers, or the like, and provides connection with devices 102.

In some embodiments, one or more of devices 102 are configured to perform management functions corresponding to network 104. In various embodiments, one or more of devices 102 are configured as one or more of an operations support system (OSS), an element management system (EMS), a network management system (NMS), an access and mobility management function (AMF), or other system or function configured to perform one or more activities supporting operations of network 104.

In some embodiments, one or more of the interconnected devices 102 of network 104 are configured as one or more of a local area network (LAN), a wide area network (WAN), a metropolitan area network (MAN), an internet area network (IAN), a campus area network (CAN), or a virtual private network (VPN). In some embodiments, one or more of the interconnected devices 102 of network 104 are configured as a backbone or core network (CN), a part of a computer network that interconnects networks, providing a path for the exchange of information between different LANs, WANs, etc.

In some embodiments, some of the interconnected devices 102 of network 104 are configured as server clusters, e.g., included in a data center. In some embodiments, the server clusters are part of a cloud computing environment.

In some embodiments, network 104 is some or all of a global system for mobile communications (GSM) RAN, a GSM/EDGE RAN, a universal mobile telecommunications system (UMTS) RAN (UTRAN), an evolved universal terrestrial radio access network (E-UTRAN), open RAN (O-RAN), or cloud-RAN (C-RAN). In some embodiments, network 104 resides between a UE 112 and one or more core networks of system 100.

In some embodiments, network 104 is some or all of a hierarchical telecommunications network, e.g., system 100, including one or more intermediate link(s), also referred to as backhaul portions in some embodiments, between a RAN and one or more core networks. Non-limiting examples of mobile backhaul implementations include fiber-based backhaul, wireless point-to-point backhaul, copper-based wireline, satellite communications, and point-to-multipoint wireless technologies. In some embodiments, backhaul refers to the side of the network that communicates with the global internet.

In the embodiment depicted in FIG. 1, network 104 includes cells 106A and 106B, which include respective base stations 108A and 108B and respective antennas 110A and 110B. In some embodiments, network 104 includes a plurality of cells including cells 106A and 106B and collectively referred to as cells 106 or, in some embodiments coverage areas 106, a plurality of base stations including base stations 108A and 108B and collectively referred to as base stations 108, and a plurality of antennas including antennas 110A and 110B and collectively referred to as antennas 110.

In the embodiment depicted in FIG. 1, a single base station 108 corresponds to single instances of each of cells 106 and antennas 110. In various embodiments, a single base station 108 corresponds to more than one instance of cells 106 and/or more than one instance of antennas 110.

In some embodiments, base stations 108 are lattice or self-supported towers, guyed towers, monopole towers, and concealed towers (e.g., towers designed to resemble trees, cacti, water towers, signs, light standards, and other types of structures). In some embodiments, a base station 108 is a cellular-enabled mobile device site where antennas and electronic communications equipment are placed, typically on a radio mast, tower, or other raised structure to create a cell 106 (or adjacent cells) in a network. The raised structure typically supports antenna(s) 110 and one or more sets of transmitter/receivers, transceivers, digital signal processors, control electronics, a remote radio head (RRH), primary and backup electrical power sources, and sheltering. Base stations 108 are known by other names such as base transceiver station, mobile phone mast, or cell tower. In some embodiments, base stations 108 are edge devices configured to wirelessly communicate with UEs 112. The edge device provides an entry point into service provider core networks. Examples include routers, routing switches, integrated access devices (IADs), multiplexers, and a variety of MAN and WAN access devices.

In at least one embodiment, an instance of antenna 110 is a sector antenna, e.g., a directional microwave antenna with a sector-shaped radiation pattern, or a plurality of sector antennae, e.g., configured to have a full-circle coverage area 106. In some embodiments, an instance of antenna 110 is a circular antenna. In some embodiments, an instance of antenna 110 operates at one or more microwave or ultra-high frequency (UHF) frequencies, e.g., ranging from 300 Megahertz (MHz) to 7.2 Gigahertz (GHz). In some embodiments, an instance of antenna 110 operates at one or more frequencies ranging from 24.2 GHz to 71.0 GHZ.

In various embodiments, a cell 106 is a three-dimensional space having a shape and size based on the configurations of the corresponding base station 108, e.g., a power level, and antenna 110, e.g., a number of sectors. In various embodiments, a cell 106 has a substantially spherical, hemispherical, conical, columnar, circular or oval disc, or other shape corresponding to a base station and antenna configuration. In various embodiments, one or both of the shape or size of a cell 106 varies over time, e.g., based on a variable base station power level and/or a variable number of activated antennae and/or antenna sectors. In some embodiments, a cell 106 is referred to as a macro-cell, a micro-cell, a pico-cell, a femto-cell, or a small cell. In some embodiments, a cell 106 is referred to as an indoor small cell (IDSC).

In some embodiments, an instance of UE 112 is a computer or computing system. In some embodiments, an instance of UE 112 has a liquid crystal display (LCD), light-emitting diode (LED) or organic light-emitting diode (OLED) screen interface, such as a graphical user interface providing a touchscreen interface with digital buttons and keyboard or physical buttons along with a physical keyboard. In some embodiments, an instance of UE 112 connects to the internet and interconnects with other devices. In some embodiments, an instance of UE 112 incorporates integrated cameras, the ability to place and receive voice and video telephone calls, video games, and Global Positioning System (GPS) capabilities. In some embodiments, an instance of UE 112 performs as a virtual machine or allows third-party apps to run as a container. In some embodiments, an instance of UE 112 is a computer (such as a tablet computer, netbook, digital media player, digital assistant, graphing calculator, handheld game console, handheld personal computer (PC), laptop, mobile internet device (MID), personal digital assistant (PDA), pocket calculator, portable medial player, or ultra-mobile PC), a mobile phone (such as a camera phone, feature phone, smartphone, or phablet), a digital camera (such as a digital camcorder, or digital still camera (DSC), digital video camera (DVC), or front-facing camera), a pager, a personal navigation device (PND), a wearable computer (such as a calculator watch, smartwatch, head-mounted display, earphones, or biometric device), or a smart card.

A UE 112 is configured to communicate with base stations 108 via signals transmitted to and from antennas 110. In some embodiments, a UE 112 is configured to operate in each of an inactive mode, an idle mode, and a connected mode. In inactive mode operation the UE 112 has no active RAN access; in connected mode operation, the UE 112 is actively connected to a RAN; and in idle mode operation, the UE has access to and from a RAN but is not actively connected to the RAN. A key difference between inactive and idle modes is that in inactive mode, the UE 112 is known to the network, i.e., the UE's context which includes its address identifiers and session data is stored at both UE 112 and the network, while in idle mode, the UE 112 is not known to the network.

FIG. 1 depicts an instance of UE 112, a UE 112U, that is further discussed below.

Network 104 includes a plurality of network nodes, referred to as nodes or RAN nodes in some embodiments. In some embodiments, a node corresponds to one or more devices 102, a combination of one or more devices 102 and one or more base stations 108, or one or more base stations 108. In some embodiments, a node corresponds to a base station 108 that is an instance of devices 102.

In some embodiments, a node corresponds to a device 102 configured as a centralized unit (CU) and one or more base stations 108 configured as distributed units (DUs). In some embodiments, a node is a next generation RAN (NG-RAN) node, e.g., a gNB an NG-eNB according to 3GPP TS 38.300 specifications.

Nodes are interconnected to each other and to network management entities, e.g., an EMS or AMF, through various interfaces. In some embodiments, interfaces between nodes and core network elements are referred to as NG interfaces. In some embodiments, interfaces between various nodes, e.g., NG-RAN nodes, are referred to as Xn interfaces.

In the embodiment depicted in FIG. 1, device 102N is a network node including mobility support 122N and a storage device 124N configured to store zone and UE identifiers 126N and AI/ML model information 128N. In some embodiments, mobility support 122N is also referred to as mobility support algorithm 122N and/or AI/ML model information 128N is also referred to as AI/ML-based model and policy parameters 128N.

In the embodiment depicted in FIG. 1, device 102N including mobility support 122N is a single instance of devices 102. In some embodiments, device 102N including mobility support 122N includes more than one instance of devices 102. Each of mobility support 122N, zone and UE identifiers 126N, and AI/ML model information 128N is further discussed below.

A zone is a portion or all of a RAN including a group of cells and a corresponding group of nodes, e.g., including device 102N. In some embodiments, a zone corresponds to a geographic region, e.g., a prefecture, bounded by one or more borders corresponding to political, physical, and/or geometric configurations. In various embodiments, a zone is some, all, or a combination of a town, a village, a city, a county, a state, a province, a country, a continent, an island, a peninsula, an isthmus, a grid portion, e.g., bounded by latitude and longitude criteria, a circular, polygonal, or other region, or the like. In some embodiments, a zone is a physically limited portion of a geographic region, e.g., some, all, or a combination of a building, e.g., a hotel or office building, a building complex, a campus, an industrial park, a city block or blocks, a shopping center, a town center or mall, a neighborhood, a town, a village, or the like.

A storage device, e.g., storage device 124N or a storage device 124U on UE 112U, is one or more computer-readable, non-volatile storage devices, e.g., a database. In some embodiments, a storage device includes a memory 504 discussed below with respect to FIG. 5.

In the embodiment depicted in FIG. 1, storage device 124N is located on device 102N. In some embodiments, storage device 124N is located externally to device 102N, e.g., on one or more servers corresponding to devices 102.

In some embodiments, storage device 124N is a database, also referred to as a RAN database in some embodiments, associated with a zone and thereby accessible by each of the nodes in the associated zone. In some embodiments, storage device 124N is a database configured to provide store/read/write services based on service-based architecture principles.

In some embodiments, a zone includes multiple instances of device 102N, each of which includes a corresponding mobility support 122N and storage device 124N configured to store corresponding instances of zone and UE identifiers 126N and AI/ML model information 128N.

Mobility support 122N is one or more sets of instructions configured to be executed on device 102N whereby zone and UE identifiers 126N are managed and transmitted to and from instances of UE 112, e.g., UE 112U, and whereby AI/ML model information 128N is managed and transmitted to and from instances of UE 112, each in accordance with an AI/ML model mobility support method 200 discussed below. In some embodiments, mobility support 122N is configured to run as a standalone program or within one or more sets of instructions. In some embodiments, mobility support 122N is configured to run on one or more of devices 102 in addition to device 102N.

Mobility support 122N is configured to, in operation, manage zone and UE identifiers 126N including generating each of a zone identifier of zone and UE identifiers 126N and a UE identifier of zone and UE identifiers 126N.

The zone identifier of zone and UE identifiers 126N is a data record configured to be interpreted by devices 102 and Ues 112 so as to identify the zone that includes device 102N. In some embodiments, mobility support 122N is configured to, in operation, generate the zone identifier based on separate information, e.g., received from a device 102 such as a RAN management system or function. In some embodiments, mobility support 122N receives the zone identifier from a device 102 such as a RAN management system or function.

In some embodiments, a portion of the zone identifier, e.g., a subset of bits of the data record, is configured to be interpreted by devices 102 and Ues 112 so as to identify a given instance of device 102N. In some embodiments, the portion of the zone identifier includes some or all of an address, e.g., an IP address, of the given instance of device 102N. In some embodiments, the portion is referred to as an address identifier.

A UE identifier of zone and UE identifiers 126N is a data record configured to be interpreted by devices 102 and Ues 112 so as to identify a given instance of UE 112U over a given time span. In various embodiments, a given time span is a predetermined time span or a variable time span having a length based on one or more criteria, e.g., a time threshold following a most recent activity within a given zone.

Devices 102 and Ues 112 are configured to store zone and UE identifiers 126N (and corresponding zone and UE identifiers 126U discussed below) in storage devices, e.g., storage device 124N, such that the corresponding zone identifiers and UE identifiers are persistent in nature and capable of being used by devices 102 and Ues 112 over multiple connected mode sessions involving multiple instances of one or both of devices 102 or Ues 112.

In some embodiments, mobility support 122N is configured to, in operation, generate the UE identifier based on separate information, e.g., received from a device 102 such as a RAN management system or function. In some embodiments, mobility support 122N receives the UE identifier from a device 102 such as a RAN management system or function. In some embodiments, the UE identifier is a serving temporary mobile subscriber identity (S-TMSI).

In some embodiments, mobility support 122N is configured to, in operation, transmit an instance of zone and UE identifiers 126N to a given UE 112U in response to receiving a transmission from the UE 112U. In some embodiments, the transmission from the UE 112U includes a RRC setup request message or a RRC resume request message received as part of establishing a session in which device 102N acts as a serving node to the UE 112U, e.g., establishing a session resulting from the UE 112U transitioning from inactive or idle mode to connected mode. In some embodiments, the transmission includes an indication of the UE transitioning to inactive or idle mode from connected mode.

In some embodiments, mobility support 122N is configured to, in operation, transmit an instance of zone and UE identifiers 126N to a given UE 112U corresponding to completing a connected mode session, e.g., returning the UE 112U to inactive or idle mode.

In some embodiments, mobility support 122N is configured to, in operation, store AI/ML model information 128N associated with zone and UE identifiers 126N in one or a combination of storage device 124N included in device 102N or configured as a database associated with the zone including device 102N. In some embodiments, storing AI/ML model information 128N corresponds to completing a connected mode session with a given UE 112U and storing the generated ML model and policies, e.g., AI/ML model information 128N in the network. In some embodiments, storing AI/ML model information 128N includes storing mobility history information (MHI) corresponding to a given UE 112U, e.g., MHI generated by device 102N or received from UE 112U and/or devices 102 other than device 102N.

An instance of AI/ML model information 128N includes at least one model generated through execution of one or more AI/ML algorithms on training data, e.g., MHI of UEs 112, including UE 112U in some embodiments. The at least one model includes an algorithm configured to generate a set of outputs consisting of predicted information and/or decision parameters, based on a set of inputs, and is thereby configured to be usable by UE 112U during one or more operations, e.g., a cell reselection operation.

In some embodiments, an instance of AI/ML model information 128N includes one or more policy parameters, e.g., a range of UE 112U speeds or strengths of signals received from base stations 108.

In some embodiments, mobility support 122N is further configured to, in operation, transmit an instance of zone and UE identifiers 126N to a given UE 112U in response to receiving a transmission from a device 102. In some embodiments, the transmission from the device 102 includes a handover request acknowledgement from the device 102 received as part of establishing a session in which device 102N acts as a serving node to the UE 112U subsequent to the device 102 acting as a serving node to the UE 112U.

In some embodiments, mobility support 122N is configured to, in operation, transmit an instance of zone and UE identifiers 126N to a given UE 112U included in a system information block (SIB).

In some embodiments, in operation, mobility support 122N is configured to respond to an instance of zone and UE identifiers 126N received from a given UE 112U by comparing the received instance of zone and UE identifiers 126N to previously generated zone and UE identifiers 126N. In various embodiments, the previously generated zone and UE identifiers 126N are stored in one or a combination of storage device 124N included in device 102N or configured as a database associated with the zone including device 102N.

In some embodiments, the received instance of zone and UE identifiers 126N is included in a RRC setup or resume request message. In some embodiments, the received instance of zone and UE identifiers 126N is included in a RRC reconfiguration complete message received as part of a handover operation.

In some embodiments, mobility support 122N is configured to, in operation, respond to a match between the received instance of zone and UE identifiers 126N and the previously generated zone and UE identifiers 126N, retrieve AI/ML model information 128N from one or a combination of storage device 124N included in device 102N or configured as a database associated with the zone including device 102N.

The previously generated zone and UE identifiers 126N are based on one or more previous sessions in which a node in the zone, e.g., device 102N or another device 102 in the zone, acted as a serving node to UE 112U.

In some embodiments, mobility support 122N is configured to, in operation, respond to a mismatch between the received instance of zone and UE identifiers 126N and one or more previously generated zone and UE identifiers 126N by generating new AI/ML model information 128N. In some embodiments, mobility support 122N is configured to respond to receiving a transmission from UE 112U, e.g., including a RRC setup request message or RRC resume request message, by generating new AI/ML model information 128N.

In some embodiments, mobility support 122N is configured to transmit the corresponding previously generated zone and UE identifiers 126N and/or newly generated zone and UE identifiers 126N to UE 112U.

UE 112U is an instance of UEs 112 including mobility support 122U and storage device 124U configured to store zone and UE identifiers 126U and AI/ML model information 128U. In some embodiments, mobility support 122U is also referred to as mobility support algorithm 122U and/or AI/ML model information 128U is also referred to as AI/ML-based model and policy parameters 128U.

Zone and UE identifiers 126U correspond to zone and UE identifiers 126N received from device 102N, and AI/ML model information 128U corresponds to AI/ML model information 128N received from device 102N.

Mobility support 122U is one or more sets of instructions configured to be executed on UE 112U whereby zone and UE identifiers 126U are managed and transmitted to and from instances of device 102, e.g., device 102N, and whereby AI/ML model information 128U received from instances of device 102N and in some embodiments applied to operations of UE 112U, each in accordance with AI/ML model mobility support method 200 discussed below. In some embodiments, mobility support 122U is configured to run as a standalone program or within one or more sets of instructions. In some embodiments, mobility support 122U is configured to run on one or more UEs 112 in addition to UE 112U.

Mobility support 122U is configured to, in operation, receive an instance of zone and UE identifiers 126U from an instance of device 102N, and store the instance of zone and UE identifiers 126U in storage device 124U. In some embodiments, the instance of zone and UE identifiers 126U is included in a SIB received from the instance of device 102N.

In some embodiments, mobility support 122U is configured to, in operation, receive the instance of zone and UE identifiers 126U included in a RRC setup or resume request message, e.g., as part of establishing a session in which the instance of device 102N acts as a serving node to UE 112U, e.g., establishing a session resulting from UE 112U transitioning from inactive or idle mode to connected mode.

In some embodiments, mobility support 122U is configured to, in operation, receive the instance of zone and UE identifiers 126U included in a RRC reconfiguration message received as part of completing a connected mode session with an instance of device 102N.

In some embodiments, mobility support 122U is configured to, in operation, receive the instance of zone and UE identifiers 126U included in a RRC reconfiguration message received, as part of a handover operation, from an instance of device 102N acting as a serving node to UE 112U subsequent to another device 102 acting as a serving node to UE 112U.

In some embodiments, mobility support 122U is configured to, in operation, receive the instance of zone and UE identifiers 126U included in a RRC reconfiguration message received, as part of a handover operation, from a device 102 acting as a serving node to UE 112U prior to device 102N acting as a serving node to UE 112U. In some embodiments, mobility support 122U receives the instance of zone and UE identifiers 126U from the device 102 included in a handover command based on a handover request acknowledgement sent from device 102N and including the instance of zone and UE identifiers 126U, e.g., in a SIB. In some embodiments, the device 102 corresponds to a vendor different from a vendor corresponding to device 102N.

Mobility support 122U is configured to, in operation, store the received zone and UE identifiers 126U in storage device 124U. In some embodiments, mobility support 122U stores the received zone and UE identifiers 126U prior to transitioning from connected mode to inactive or idle mode and retains the received zone and UE identifiers 126U in storage device 124U throughout subsequent transitions between modes.

In some embodiments, mobility support 122U is configured to, in operation, transmit the stored zone and UE identifiers 126U to a second instance of device 102N in response to either returning to connected mode from inactive or idle mode or receiving a RRC handover command from a device 102 different from the instances of device 102N, e.g., a device 102 corresponding to a vendor different from a vendor corresponding to the instances of device 102N.

In some embodiments, mobility support 122U is configured to respond to returning to connected mode from inactive or idle mode by transmitting the stored zone and UE identifiers 126U in a RRC setup request message or a RRC resume request message.

In some embodiments, mobility support 122U is configured to respond to receiving the RRC handover command by transmitting the stored zone and UE identifiers 126U in a RRC reconfiguration complete message. In some embodiments, mobility support 122U obtains the zone and UE identifier 126U from a plurality of stored instances of zone and UE identifiers 126U.

In some embodiments, mobility support 122U is configured to, in operation, receive, from the second instance of device 102N, AI/ML model information 128U, and apply the received AI/ML model information 128U to an operation of UE 112U, e.g., an idle mode cell reselection operation.

In various embodiments, AI/ML model information 128U corresponds to AI/ML model information 128N previously generated and retrieved by the second instance of device 102N or to AI/ML model information 128N newly generated by the second instance of device 102N, as discussed above.

In some embodiments, mobility support 122U is configured to, in operation, delete one or both of a stored zone or UE identifier of the stored zone and UE identifiers 126U based on one or more deletion criteria, e.g., after expiration of a preconfigured timer, and/or by deleting an oldest identifier upon reaching a predetermined maximum number of identifiers, or in response to receiving an explicit deletion command or other deletion indication from an instance of device 102N.

System 100 including one or more instances of device 102N and/or one or more instances of UE 112U configured as discussed above is thereby configured to perform some or all of transmitting zone and UE identifiers 126N from a first instance of device 102N to UE 112U, wherein the zone identifier corresponds to a first zone of network 104 including cells 106 and devices 102 including the first instance of device 102N, storing zone and UE identifiers 126U in storage device 124U, transmitting zone and UE identifiers 126U from UE 112U to a second instance of device 102N, sending AI/ML model information 128N from the second instance of device 102N to UE 112U, wherein the AI/ML model information 128N is based on zone and UE identifiers 126N, and applying AI/ML model information 128U to an operation of UE 112U.

By storing zone and UE identifiers 126U and transmitting zone and UE identifiers 126U from UE 112U to the second instance of device 102N, the second instance of device 102N is able to determine whether previously generated AI/ML model information 128N is available to be transmitted to UE 112U. The previously generated AI/ML model information 128N is thereby available to be applied by UE 112U to operations in scenarios in which previously generated AI/ML-based model information would otherwise be unavailable, e.g., while UE 112U transitions from inactive or idle mode to connected mode or as part of a UE 112U handover operation. Compared to approaches in which previously generated AI/ML-based model information is unavailable in such scenarios, system 100, UEs 112U, and devices 102N are thereby configured such that UE operations are more efficient by being able to leverage previously generated AI/ML model information 128N.

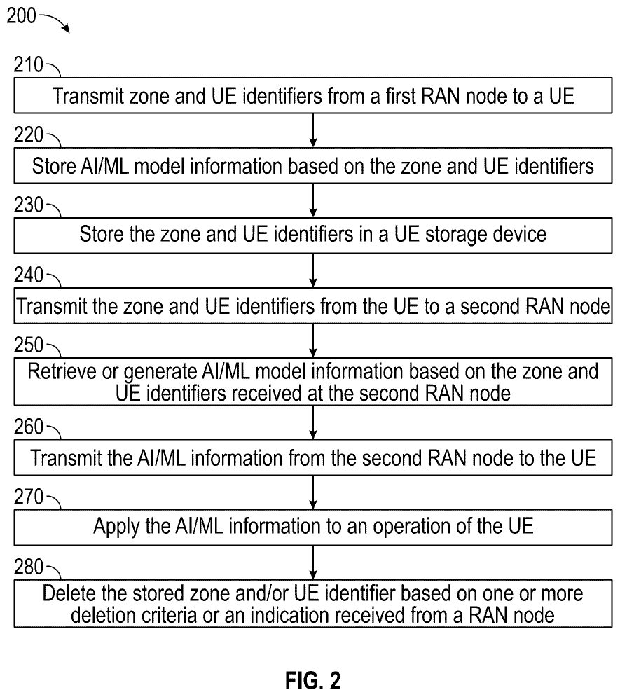

FIG. 2 is a flowchart of AI/ML model mobility support method 200, in accordance with some embodiments. AI/ML model mobility support method 200, also referred to as a method 200 or a method of operating a RAN in some embodiments, is operable on a telecommunication system, e.g., telecommunication system 100 discussed above with respect to FIG. 1.

Additional operations may be performed before, during, between, and/or after the operations of method 200 depicted in FIG. 2, and some other operations may only be briefly described herein. In some embodiments, other orders of operations of method 200 are within the scope of the present disclosure. In some embodiments, one or more operations of method 200 are not performed.

In some embodiments, some or all of the operations of method 200 are included in another method, e.g., a method of operating a telecommunication system. In some embodiments, some or all of the operations of method 200 discussed below are repeated, e.g., as part of operating a telecommunication system.

In some embodiments, some or all of the operations of method 200 discussed below are capable of being performed automatically, e.g., by device 102N including mobility support 122N and/or UE 112 including mobility support 122U, each discussed above with respect to FIG. 1 and/or by using processing circuitry 502 discussed below with respect to FIG. 5.

The operations of method 200 are discussed below with reference to various features of system 100 that are also discussed above respect to FIG. 1.

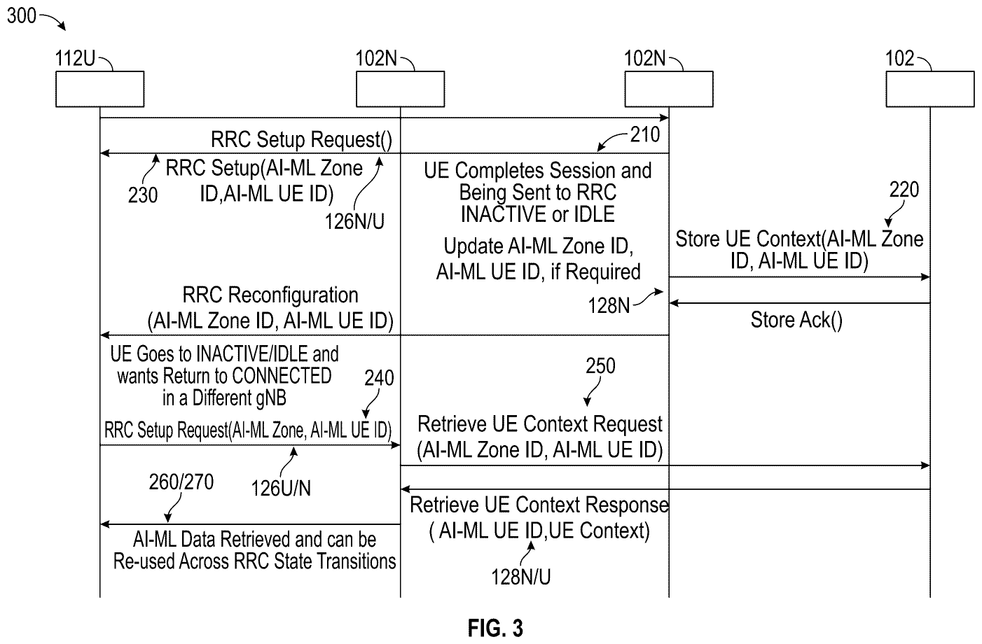

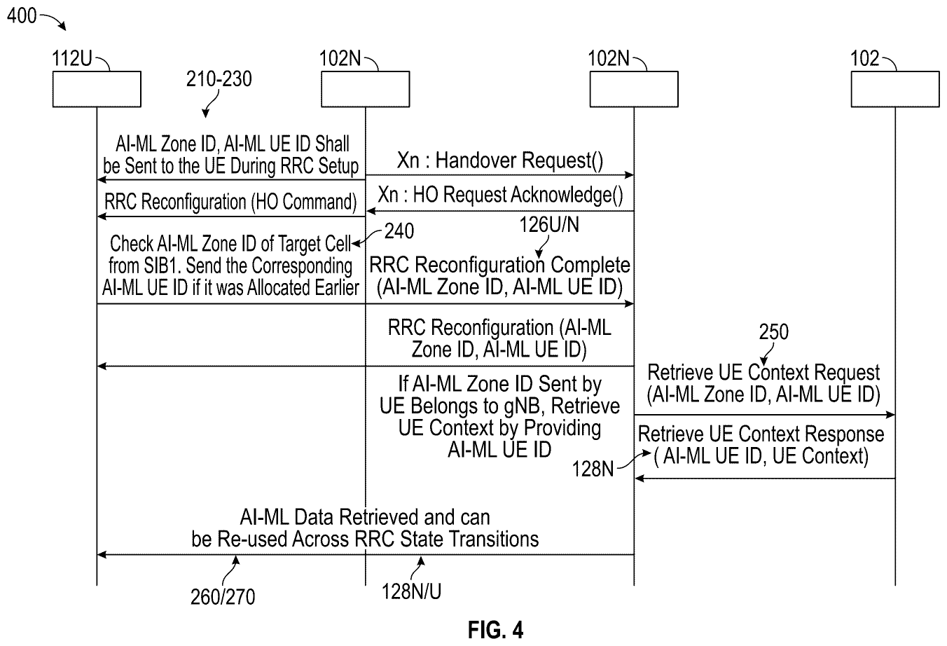

FIGS. 3 and 4 depict non-limiting examples that illustrate the execution of some or all of the operations of method 200 using embodiments of system 100, as discussed below.

At operation 210, in some embodiments, zone and UE identifiers are transmitted from a first RAN node to a UE. Transmitting the zone and UE identifiers from the first RAN node to the UE includes transmitting zone and UE identifier 126N from a first instance of device 102N to UE 112U as discussed above.

At operation 220, in some embodiments, AI/ML model information based on the zone and UE identifiers is stored. Storing the AI/ML model information based on the zone and UE identifiers includes using device 102N to store AI/ML model information 128N in one or a combination of storage device 124N included in device 102N or configured as a database associated with the zone including device 102N as discussed above.

At operation 230, in some embodiments, the zone and UE identifiers are stored in a UE storage device. Storing the zone and UE identifiers in the UE storage device includes using UE 112U to store zone and UE identifier 126U in storage device 124U as discussed above.

At operation 240, in some embodiments, the zone and UE identifiers are transmitted from the UE to a second RAN node. Transmitting the zone and UE identifiers from the UE to the second RAN node includes transmitting zone and UE identifier 126U from UE 112U to a second instance of device 102N as discussed above.

At operation 250, in some embodiments, AI/ML model information based on the zone and UE identifiers received at the second RAN node is retrieved or generated. Retrieving or generating the AI/ML model information based on the zone and UE identifiers received at the second RAN node includes using the second instance of device 102N to retrieve or generate AI/ML model information 128N as discussed above.

At operation 260, in some embodiments, the AI/ML model information is transmitted from the second RAN node to the UE. Transmitting the AI/ML model information from the second RAN node to the UE includes transmitting AI/ML model information 128N from the second instance of device 102N to UE 112U as discussed above.

At operation 270, in some embodiments, the AI/ML information is applied to an operation of the UE. Applying the AI/ML information to the operation of the UE includes applying AI/ML model information 128U to operation of UE 112U as discussed above.

At operation 280, in some embodiments, the stored zone and/or UE identifier is deleted based on one or more deletion criteria. Deleting the stored zone and/or UE identifier based on one or more deletion criteria includes using UE 112U to delete some or all of a stored instance of zone and UE identifier 126U as discussed above.

By performing some or all of the operations of method 200, a system, e.g., system 100, automatically performs some or all of transmitting a UE identifier and a zone identifier from a first node of a RAN to a UE, wherein the zone identifier corresponds to a first zone of the RAN including a plurality of cells and a plurality of nodes including the first node, storing each of the UE and zone identifiers in a storage device of the UE, transmitting the UE and zone identifiers from the UE to a second node of the RAN, sending an AI/ML-based model and policy parameters from the second node to the UE, wherein the AI/ML-based model and policy parameters are based on the UE identifier and the zone identifier, and applying the AI/ML-based model and policy parameters to an operation of the UE, whereby the benefits discussed above with respect to system 100 are capable of being realized.

FIG. 3 is a flowchart of an AI/ML model mobility support method 300, in accordance with some embodiments. AI/ML model mobility support method 300, also referred to as method 300 or a method of operating a RAN in some embodiments, is a non-limiting example of some or all of method 200 discussed above.

Method 300 corresponds to a scenario in which an instance of UE 112U transitions in and out of connected mode sessions with two instances of devices 102N, and AI/ML model information 128N is retrieved from a database on a device 102 based on stored zone and UE identifiers 128U.

In the embodiment depicted in FIG. 3, in operation 210, a first instance of device 102N transmits zone and UE identifiers 128N to UE 112U, which transitions from connected mode to inactive or idle mode. UE 112U stores zone and UE identifiers 128N as zone and UE identifiers 128U in operation 230. The first instance of device 102N stores AI/ML model information 128N in the database on device 102 in operation 220. In operation 240, UE 112U returns to connected mode and transmits zone and UE identifiers 128U to a second instance of device 102N. Based on received zone and UE identifiers 128N, the second instance of device 102N retrieves AI/ML model information 128N from the database on device 102 in operation 250. In operations 260 and 270, the second instance of device 102N transmits the retrieved AI/ML model information 128N to UE 112U which applies AI/ML model information 128N as AI/ML model information 128U in one or more operations.

By executing some or all of the operations of method 200 in accordance with the non-limiting example of method 300, the benefits discussed above with respect to FIGS. 1 and 2 are capable of being realized.

FIG. 4 is a flowchart of an AI/ML model mobility support method 400, in accordance with some embodiments. AI/ML model mobility support method 400, also referred to as method 400 or a method of operating a RAN in some embodiments, is a non-limiting example of some or all of method 200 discussed above.

Method 400 corresponds to a scenario in which an instance of UE 112U is included in a handover operation between two instances of devices 102N, and AI/ML model information 128N is retrieved from a database on a device 102 based on stored zone and UE identifiers 128U.

In the embodiment depicted in FIG. 4, in operations 210-230, UE 112U stores zone and UE identifiers 128U based on a prior connected mode session with an instance of device 102N (not depicted) in which AI/ML model information 128N has been stored in the database on device 102. A subsequent handover operation is performed from a first instance of device 102N to a second instance of device 102N. In operation 240, UE 112U completes the handover operation by transmitting a RRC reconfiguration complete message including zone and UE identifiers 128U (corresponding to stored zone and UE identifiers 126U) to the second instance of device 102N. Based on received zone and UE identifiers 128N, the second instance of device 102N retrieves AI/ML model information 128N from the database on device 102 in operation 250. In operations 260 and 270, the second instance of device 102N transmits the retrieved AI/ML model information 128N to UE 112U which applies AI/ML model information 128N as AI/ML model information 128U in one or more operations.

By executing some or all of the operations of method 200 in accordance with the non-limiting example of method 400, the benefits discussed above with respect to FIGS. 1 and 2 are capable of being realized.

FIG. 5 is a functional block diagram of a computer or processor-based device 500 upon which or by which an embodiment is implemented.

Processor-based device 500 is programmed to facilitate automated generation and/or modification of cell reselection policies, as described herein, and includes, for example, bus 508, processing circuitry 502, also referred to a processor 502 in some embodiments, and memory 504 components.

In some embodiments, processor-based device 500 includes a communication mechanism such as bus 508 for transferring information and/or instructions among the components of processor-based device 500. Processing circuitry 502 is connected to bus 508 to obtain instructions for execution and process information stored in, for example, memory 504. In some embodiments, processing circuitry 502 is also accompanied with one or more specialized components to perform certain processing functions and tasks such as one or more digital signal processors (DSP), or one or more application-specific integrated circuits (ASIC). A DSP typically is configured to process real-world signals (e.g., sound) in real time independently of processing circuitry 502. Similarly, an ASIC is configurable to perform specialized functions not easily performed by a more general-purpose processor. Other specialized components to aid in performing the functions described herein optionally include one or more field programmable gate arrays (FPGA), one or more controllers, or one or more other special-purpose computer chips.

In one or more embodiments, processing circuitry (or multiple processors) 502 performs a set of operations on information as specified by a set of instructions stored in memory 504 related to cell reselection policies, e.g., a mobility support algorithm 516 corresponding to mobility support 122N or 122U discussed above with respect to FIGS. 1 and 2. The execution of the instructions causes the processor to perform specified functions.

Processing circuitry 502 and accompanying components are connected to memory 504 via bus 508. Memory 504 includes one or more of dynamic memory (e.g., RAM, magnetic disk, writable optical disk, or the like) and static memory (e.g., ROM, CD-ROM, or the like) for storing executable instructions that when executed perform the operations described herein to facilitate automated network configuration. In some embodiments, memory 504 also stores the data associated with or generated by the execution of the operations, e.g., zone and UE identifiers 520 which corresponds to zone and UE identifiers 126N or 126U, and AI/ML model information 522 which corresponds to AI/ML model information 128U or 128N, each discussed above with respect to FIGS. 1 and 2.

In one or more embodiments, memory 504, such as a random-access memory (RAM) or any other dynamic storage device, stores information including processor instructions for facilitating network application implementation. Dynamic memory allows information stored therein to be changed. RAM allows a unit of information stored at a location called a memory address to be stored and retrieved independently of information at neighboring addresses. Memory 504 is also used by processing circuitry 502 to store temporary values during execution of processor instructions. In various embodiments, memory 504 includes a read only memory (ROM) or any other static storage device coupled to bus 508 for storing static information, including instructions, that is not capable of being changed by processing circuitry 502. Some memory is composed of volatile storage that loses the information stored thereon when power is lost. In some embodiments, memory 504 includes a non-volatile (persistent) storage device, such as a magnetic disk, optical disk, or flash card, for storing information, including instructions, that persists even when device 500 is turned off or otherwise loses power.

The term “computer-readable medium” as used herein refers to any medium that participates in providing information to processing circuitry 502, including instructions 506 for execution. Such a medium takes many forms, including, but not limited to computer-readable storage medium (e.g., non-volatile media, volatile media). Non-volatile media includes, for example, optical or magnetic disks. Volatile media include, for example, dynamic memory. Common forms of computer-readable media include, for example, a floppy disk, a flexible disk, a hard disk, a magnetic tape, another magnetic medium, a CD-ROM, CDRW, DVD, another optical medium, punch cards, paper tape, optical mark sheets, another physical medium with patterns of holes or other optically recognizable indicia, a RAM, a PROM, an EPROM, a FLASH-EPROM, an EEPROM, a flash memory, another memory chip or cartridge, or another medium from which a computer reads. The term computer-readable storage medium is used herein to refer to a computer-readable medium.

Instructions 506 also include a user interface 518, one or more sets of instructions configured to allow effective operation and control of device 500 by a user. In some embodiments, user interface 518 is configured to operate though one or more layers, including a human-machine interface (HMI) that interfaces machines with physical input hardware such as keyboards, mice, or game pads, and output hardware such as computer monitors, speakers, printers, and other suitable user interfaces.

In some embodiments, a UE includes a memory having non-transitory instructions stored therein, and a processor coupled to the memory, and being configured to execute the instructions, thereby causing the UE to while operating in a connected mode, receive each of a zone identifier and a UE identifier from a first RAN node of a RAN, wherein the zone identifier corresponds to a zone of the RAN including a plurality of cells and a plurality of RAN nodes including the first RAN node, store each of the zone identifier and the UE identifier in a storage device of the UE, and transmit the zone identifier and the UE identifier to a second RAN node responsive to returning to the connected mode from an inactive mode or an idle mode, or receiving, from the first RAN node or a third RAN node, a RRC handover command corresponding to a handover to the second RAN node. In some embodiments, the instructions are executable by the processor to cause the UE to further receive, from the second RAN node, an AI/ML-based model and/or policy parameters, and apply the AI/ML-based model and/or policy parameters to an operation of the UE, wherein the AI/ML-based model and/or policy parameters include a previously generated AI/ML-based model and/or policy parameters corresponding to the second RAN node being in the zone corresponding to the stored zone identifier or a newly generated AI/ML-based model and/or policy parameters corresponding to the second RAN node being in a zone other than the zone corresponding to the stored zone identifier. In some embodiments, the instructions are executable by the processor to cause the UE to transmit the zone identifier and the UE identifier to the second RAN node included in a RRC setup request message or a RRC resume request message when responding to returning to the connected mode from the inactive mode or the idle mode, and a RRC reconfiguration complete message when responding to receiving the RRC handover command from the first or third RAN node. In some embodiments, the instructions are executable by the processor to cause the UE to further, responsive to receiving the RRC handover command from the first or third RAN node, compare the zone identifier obtained from a system information broadcast of the second RAN node to a plurality of stored zone identifiers, and obtain the UE identifier corresponding to the zone identifier from a plurality of stored UE identifiers. In some embodiments, the instructions are executable by the processor to cause the UE to receive, store, and transmit the zone identifier including an address identifier of the first RAN node. In some embodiments, the instructions are executable by the processor to cause the UE to receive a new UE identifier and a new zone identifier from the third RAN node, thereby indicating that the third RAN node corresponds to a first vendor different from a second vendor corresponding to the first and second RAN nodes. In some embodiments, the instructions are executable by the processor to further cause the UE to delete one or both of the stored zone identifier or the UE identifier based on one or more deletion criteria or in response to an indication from the first, second, or another RAN node.

In some embodiments, a RAN node includes a memory having non-transitory instructions stored therein and a processor coupled to the memory, and being configured to execute the instructions, thereby causing the RAN node to receive a transmission from a UE as part of establishing a connected mode session including the RAN node serving the UE, in response to the transmission including a first zone identifier and a UE identifier, compare the first zone identifier to a second zone identifier of a zone of a RAN including a plurality of cells and a plurality of RAN nodes including the RAN node, in response to a match between the first and second zone identifiers, retrieve, from a storage device, an existing artificial intelligence and machine learning (AI/ML)-based model associated with the UE identifier based on a previous session comprising one of the plurality of RAN nodes serving the UE, or in response to a mismatch between the first and second zone identifiers or the transmission lacking the first zone identifier, generate a new AI/ML-based model, and transmit the corresponding existing or new AI/ML-based model, the UE identifier, and the second zone identifier to the UE. In some embodiments, the instructions are executable by the processor to cause the RAN node to receive the first zone identifier and the UE identifier included in the transmission including a RRC setup request message or a RRC resume request message as part of establishing the connected mode session. In some embodiments, the RAN corresponds to a first vendor, and the instructions are executable by the processor to cause the RAN node to establish the connected mode session as part of a handover of the UE from a second vendor different from the first vendor, and receive the first zone identifier and the UE identifier included in the transmission including a RRC reconfiguration complete message. In some embodiments, the instructions are executable by the processor to cause the RAN node to retrieve the AI/ML-based model from the storage device including a database associated with the zone comprising the plurality of RAN nodes including the RAN node. In some embodiments, the RAN node is a first RAN node of the plurality of RAN nodes, and the instructions are executable by the processor to cause the first RAN node to receive the first zone identifier including an address identifier of a second RAN node of the plurality of RAN nodes and retrieve the AI/ML-based model from the storage device associated with the second RAN node. In some embodiments, the instructions are executable by the processor to cause the RAN node to transmit, to the UE, policy parameters corresponding to the existing or new AI/ML-based model. In some embodiments, the instructions are executable by the processor to further cause the RAN node to store the corresponding existing or new AI/ML-based model as part of completing the connected mode session.

In some embodiments, a method of operating a RAN includes transmitting a UE identifier and a zone identifier from a first node of the RAN to a UE, wherein the zone identifier corresponds to a first zone of the RAN including a plurality of cells and a plurality of nodes including the first node, storing each of the UE identifier and the zone identifier in a storage device of the UE, transmitting the UE identifier and the zone identifier from the UE to a second node of the RAN, sending an AI/ML-based model and policy parameters from the second node to the UE, wherein the AI/ML-based model and policy parameters are based on the UE identifier and the zone identifier, and applying the AI/ML-based model and policy parameters to an operation of the UE. In some embodiments, transmitting the UE identifier and the zone identifier from the first node to the UE includes broadcasting a SIB from the first node to the UE or sending a dedicated message from the first node to the UE. In some embodiments, transmitting the UE identifier and the zone identifier from the UE to the second node includes the UE transmitting a RRC setup request message or a RRC resume request message as part of transitioning to a connected mode from an inactive mode or an idle mode. In some embodiments, the first and second nodes correspond to a first vendor, and transmitting the UE identifier and the zone identifier from the UE to the second node includes the UE transmitting a RRC reconfiguration complete message as part of a handover of the UE to the second node from a third node corresponding to a second vendor different from the first vendor. In some embodiments, transmitting the AI/ML-based model and policy parameters includes retrieving, from a storage device, a previously generated AI/ML-based model and policy parameters in response to the second node being in the plurality of nodes of the first zone, or generating a new AI/ML-based model and policy parameters in response to the second node being outside of the first zone. In some embodiments, retrieving the previously generated AI/ML-based model and policy parameters from the storage device includes retrieving the previously generated AI/ML-based model and policy parameters from a database associated with the first zone, or retrieving the previously generated AI/ML-based model and policy parameters from the storage device associated with the first node, the second node, or a third node in the plurality of nodes of the first zone.

The foregoing outlines features of several embodiments so that those skilled in the art better understand the aspects of the present disclosure. Those skilled in the art appreciate that they readily use the present disclosure as a basis for designing or modifying other processes and structures for carrying out the same purposes and/or achieving the same advantages of the embodiments introduced herein. Those skilled in the art also realize that such equivalent constructions do not depart from the spirit and scope of the present disclosure, and that they make various changes, substitutions, and alterations herein without departing from the spirit and scope of the present disclosure.

What is claimed is:

1. A user equipment (UE) comprising:
a memory having non-transitory instructions stored therein; and
a processor coupled to the memory, and being configured to execute the instructions, thereby causing the UE to:
while operating in a connected mode, receive each of a zone identifier and a UE identifier from a first radio access network (RAN) node of a RAN, wherein the zone identifier corresponds to a zone of the RAN comprising a plurality of cells and a plurality of RAN nodes comprising the first RAN node;
store each of the zone identifier and the UE identifier in a storage device of the UE; and
transmit the zone identifier and the UE identifier to a second RAN node responsive to:
returning to the connected mode from an inactive mode or an idle mode, or
receiving, from the first RAN node or a third RAN node, a radio resource control (RRC) handover command corresponding to a handover to the second RAN node.

2. The UE of claim 1, wherein the instructions are executable by the processor to cause the UE to further:
receive, from the second RAN node, an artificial intelligence and machine learning (AI/ML)-based model and/or policy parameters; and
apply the AI/ML-based model and/or policy parameters to an operation of the UE,
wherein the AI/ML-based model and/or policy parameters comprise:
a previously generated AI/ML-based model and/or policy parameters corresponding to the second RAN node being in the zone corresponding to the stored zone identifier; or
a newly generated AI/ML-based model and/or policy parameters corresponding to the second RAN node being in a zone other than the zone corresponding to the stored zone identifier.

3. The UE of claim 1, wherein the instructions are executable by the processor to cause the UE to transmit the zone identifier and the UE identifier to the second RAN node included in:
a RRC setup request message or a RRC resume request message when responding to returning to the connected mode from the inactive mode or the idle mode, and
a RRC reconfiguration complete message when responding to receiving the RRC handover command from the first or third RAN node.

4. The UE of claim 1, wherein the instructions are executable by the processor to cause the UE to further, responsive to receiving the RRC handover command from the first or third RAN node:
compare the zone identifier obtained from a system information broadcast of the second RAN node to a plurality of stored zone identifiers, and
obtain the UE identifier corresponding to the zone identifier from a plurality of stored UE identifiers.

5. The UE of claim 1, wherein the instructions are executable by the processor to cause the UE to receive, store, and transmit the zone identifier comprising an address identifier of the first RAN node.

6. The UE of claim 1, wherein the instructions are executable by the processor to cause the UE to receive a new zone identifier and a new UE identifier from the third RAN node, thereby indicating that the third RAN node corresponds to a first vendor different from a second vendor corresponding to the first and second RAN nodes.

7. The UE of claim 1, wherein the instructions are executable by the processor to further cause the UE to delete one or both of the stored zone identifier or the UE identifier based on one or more deletion criteria or in response to an indication received from the first, second, or another RAN node.

8. A radio access network (RAN) node, comprising:
a memory having non-transitory instructions stored therein; and
a processor coupled to the memory, and being configured to execute the instructions, thereby causing the RAN node to:
receive a transmission from a user equipment (UE) as part of establishing a connected mode session comprising the RAN node serving the UE;
in response to the transmission comprising a first zone identifier and a UE identifier, compare the first zone identifier to a second zone identifier of a zone of a RAN comprising a plurality of cells and a plurality of RAN nodes including the RAN node;
in response to a match between the first and second zone identifiers, retrieve, from a storage device, an existing artificial intelligence and machine learning (AI/ML)-based model associated with the UE identifier based on a previous session comprising one of the plurality of RAN nodes serving the UE, or
in response to a mismatch between the first and second zone identifiers or the transmission lacking the first zone identifier, generate a new AI/ML-based model; and
transmit the corresponding existing or new AI/ML-based model, the UE identifier, and the second zone identifier to the UE.

9. The RAN node of claim 8, wherein the instructions are executable by the processor to cause the RAN node to receive the first zone identifier and the UE identifier included in the transmission comprising a radio resource control (RRC) setup request message or a RRC resume request message as part of establishing the connected mode session.

10. The RAN node of claim 8, wherein
the RAN corresponds to a first vendor, and
the instructions are executable by the processor to cause the RAN node to:
establish the connected mode session as part of a handover of the UE from a second vendor different from the first vendor, and
receive the first zone identifier and the UE identifier included in the transmission comprising a RRC reconfiguration complete message.

11. The RAN node of claim 8, wherein the instructions are executable by the processor to cause the RAN node to retrieve the AI/ML-based model from the storage device comprising a database associated with the zone comprising the plurality of RAN nodes including the RAN node.

12. The RAN node of claim 8, wherein
the RAN node is a first RAN node of the plurality of RAN nodes, and
the instructions are executable by the processor to cause the first RAN node to:
receive the first zone identifier comprising an address identifier of a second RAN node of the plurality of RAN nodes; and
retrieve the AI/ML-based model from the storage device associated with the second RAN node.

13. The RAN node of claim 8, wherein the instructions are executable by the processor to cause the RAN node to transmit, to the UE, policy parameters corresponding to the existing or new AI/ML-based model.

14. The RAN node of claim 8, wherein the instructions are executable by the processor to further cause the RAN node to store the corresponding existing or new AI/ML-based model as part of completing the connected mode session.

15. A method of operating a radio access network (RAN), the method comprising:
transmitting a user equipment (UE) identifier and a zone identifier from a first node of the RAN to a UE, wherein the zone identifier corresponds to a first zone of the RAN comprising a plurality of cells and a plurality of nodes comprising the first node;
storing each of the UE identifier and the zone identifier in a storage device of the UE;
transmitting the UE identifier and the zone identifier from the UE to a second node of the RAN;
sending an artificial intelligence and machine learning (AI/ML)-based model and policy parameters from the second node to the UE, wherein the AI/ML-based model and policy parameters are based on the UE identifier and the zone identifier; and
applying the AI/ML-based model and policy parameters to an operation of the UE.

16. The method of claim 15, wherein the transmitting the UE identifier and the zone identifier from the first node to the UE comprises broadcasting a system information block (SIB) from the first node to the UE or sending a dedicated message from the first node to the UE.

17. The method of claim 15, wherein the transmitting the UE identifier and the zone identifier from the UE to the second node comprises the UE transmitting a radio resource control (RRC) setup request message or a RRC resume request message as part of transitioning to a connected mode from an inactive mode or an idle mode.

18. The method of claim 15, wherein
the first and second nodes correspond to a first vendor, and
the transmitting the UE identifier and the zone identifier from the UE to the second node comprises the UE transmitting a radio resource control (RRC) reconfiguration complete message as part of a handover of the UE to the second node from a third node corresponding to a second vendor different from the first vendor.

19. The method of claim 15, wherein the transmitting the AI/ML-based model and policy parameters comprises:
retrieving, from a storage device, a previously generated AI/ML-based model and policy parameters in response to the second node being in the plurality of nodes of the first zone, or
generating a new AI/ML-based model and policy parameters in response to the second node being outside of the first zone.

20. The method of claim 19, wherein the retrieving the previously generated AI/ML-based model and policy parameters from the storage device comprises:
retrieving the previously generated AI/ML-based model and policy parameters from a database associated with the first zone, or
retrieving the previously generated AI/ML-based model and policy parameters from the storage device associated with the first node, the second node, or a third node in the plurality of nodes of the first zone.
